(19) United States
(12) Patent Application Publication
(10) Pub. No.: US 2026/0133926 A1
(43) Pub. Date: May 14, 2026

(54) HOST BRIDGE DEVICE

(71) Applicant: PIXART IMAGING INC., Hsin-Chu County (TW)

(72) Inventor: Ping-Shun ZEUNG, Hsin-Chu County (TW)

(21) Appl. No.: 19/215,342

(22) Filed: May 22, 2025

Related U.S. Application Data
(60) Provisional application No. 63/719,682, filed on Nov. 13, 2024.
(60) Provisional application No. 63/726,670, filed on Dec. 2, 2024.

(51) Int. Cl. G06F 13/40; G06F 13/42

(52) U.S. Cl. CPC G06F 13/4022; G06F 13/4282; G06F 2213/4004

(57) ABSTRACT

There is provided a host bridge device including a host communication device and a USB hub. The host communication device is used to build up a communicate channel between two hosts to transmit file data, video data or screen data therebetween. The USB hub is used to provide downstream USB peripheral devices connected thereto to be accessed by one of the two hosts.

### CROSS REFERENCE TO RELATED APPLICATION

The present application claims the priority benefit of U.S. Provisional Application Ser. Number U.S. 63/719,682, filed on Nov. 13, 2024, and U.S. 63/726,670, filed on Dec. 2, 2024, the disclosures of which are hereby incorporated by reference herein in their entirety.

### FIELD OF THE DISCLOSURE

This disclosure generally relates to a host bridge device and, more particularly, to a host bridge device that uses a host communication device to perform data transmission between two hosts and uses a universal serial bus (USB) hub to switch accessed targets of peripheral devices between the two devices, and an operating method thereof.

### BACKGROUND OF THE DISCLOSURE

The conventional USB switch is able to switch a controlled target by a mouse device and a keyboard device among two hosts. For example, the USB switch is arranged with a button, and a user switches the controlled target of the mouse device and the keyboard device by pressing the button. However, different hosts are not able to communicate to each other through the USB switch.

The information disclosed in this BACKGROUND is merely intended to increase understanding of the general background of the invention and should not be taken as an admission or in any way implied that the relevant information constitutes prior art that is already known to a person of ordinary skill in the art.

### SUMMARY

Accordingly, the present disclosure provides a host bridge device that is able to perform communication between two hosts and to switch an access right of USB peripheral devices, and an operating method thereof.

In the present disclosure, one of the two hosts to be coupled to the host bridge device is connected to the host bridge device using a wired connection or a wireless connection.

The present disclosure provides a host bridge device including a first port, a second port, a switch, a hub and a host communication device. The switch includes a first connection end and a second connection end respectively connected to the first port and the second port. The hub is directly connected to a third connection end of the switch. The host communication device is directly connected to a fourth connection end of the switch.

The present disclosure further provides a host bridge device including a first hub, a second hub, a third hub, a host communication module and a switch. The first hub is configured to be coupled to a first host. The second hub is configured to be coupled to a second host. The third hub is configured to be coupled to multiple USB peripheral devices. The host communication device is directly connected between the first hub and the second hub. The switch is configured to couple the third hub to the first hub or the second hub.

The present disclosure further provides a host bridge device including a first hub, a second hub, a host communication module and a Bluetooth module. The first hub is configured to be coupled to a first host. The second hub is configured to be coupled to a second host. The host communication device is directly connected between the first hub and the second hub. The Bluetooth module is configured to be wiredly connected to one of the first host and the second host, and wirelessly coupled to the other one of the first host and the second host.

### BRIEF DESCRIPTION OF DRAWINGS

Other objects, advantages, and novel features of the present disclosure will become more apparent from the following detailed description when taken in conjunction with the accompanying drawings.

FIG. 1 is a schematic block diagram of a host communication system according to a first embodiment of the present disclosure.

FIG. 2 is a schematic block diagram of a host communication system according to a second embodiment of the present disclosure.

FIG. 3 is a schematic block diagram of a host communication device of a host bridge device according to one embodiment of the present disclosure.

FIG. 4 is an operating method of a human input device of a host communication device according to one embodiment of the present disclosure.

FIG. 5 is a schematic block diagram of a host communication system according to a third embodiment of the present disclosure.

FIG. 6 is a schematic block diagram of a host communication system according to a fourth embodiment of the present disclosure.

FIG. 7 is an operating method of a human input device of a host communication device according to another embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide a host bridge device used to build up a communication channel between a first host and a second host. The host bridge device includes a host communication device used to transmit proprietary data, self/vendor-defined data, keyboard event raw data and/or mouse event raw data between the first host and the second host. The host bridge device further switches, via a universal serial bus (USB) switch, the first host or the second host to access multiple USB peripheral devices, e.g., including peripheral devices that can be connected to a host via a USB connector such as a flash drive, a mouse device, a keyboard device, a joystick, a scanner, a printer or the like, but not limited to.

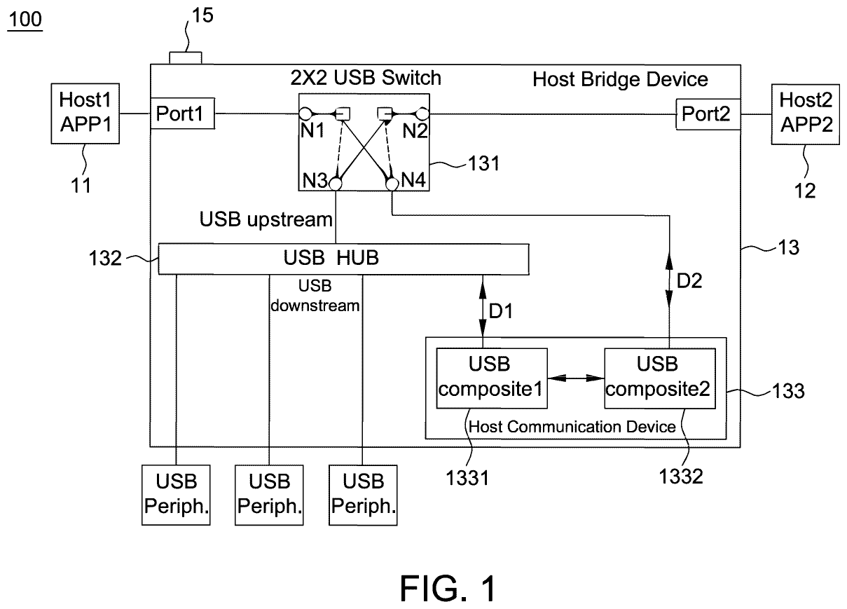

Please refer to FIG. 1, it is a schematic block diagram of a host communication system 100 according to a first embodiment of the present disclosure. The host communication system 100 includes a host bridge device 13, a first host 11 and a second host 12. The first host 11 and the second host 12 are able to be plugged in the host bridge device 13 to connect thereto and unplugged from the host bridge device 13 to disconnect therefrom. The first host 11 and the second host 12 are computers that are connected to USB ports (e.g., shown as Port1 and Port2 in FIG. 1) via a USB connector, e.g., including notebook computers, desktop computers, work stations, smart phones or the like without particular limitations.

The first host 11 is embedded with first application software APP1. The second host 12 is embedded with second application software APP2. The first application software APP1 and the second application software APP2 are respectively installed on the first host 11 and the second host 12 via a portable device (e.g., flash disk) or network.

In the first embodiment, the host bridge device 13 includes a switch 131, a hub 132, a host communication device 133, a first port (e.g., shown as Port1) and a second port (e.g., shown as Port2). The first port is for being unplugged or plugged by the first host 11. The second port is for being unplugged or plugged by the second host 12.

The switch 131 has connection ends N1 and N2 respectively connected to the first port and the second port. In one aspect, the switch is a 2×2 USB switch (abbreviated as switch herein for illustration purposes), and is used to couple the first port to one of the hub 132 and the host communication device 133, and to couple the second port to the other one of the hub 132 and the host communication device 133.

In one aspect, the host bridge device 13 includes a physical button or knob 15, and when the physical button or knob 15 is operated by a user, the switch 131 switches to connect in either solid lines (i.e. connecting N1 to N4 and N2 to N3) or dashed lines (i.e. connecting N1 to N3 and N2 to N4) shown in FIG. 1.

In another aspect, switching of the switch 131 is controlled by APP1 or APP2, e.g., a software button (or icon) being shown on a screen of the first host 11 and/or the second host 12, and the connection switching is performed when the software button (or icon) is clicked by a cursor.

The hub 132 is preferable a USB hub with multiple connection ports. The hub 132 is directly connected to the switch 131, e.g., a connection end N3 thereof. For example, when the switch 131 is connected by solid lines shown in FIG. 1, the multiple USB peripheral devices are accessed by the second host 12; whereas, when the switch 131 is connected by dashed lines shown in FIG. 1, the multiple USB peripheral devices are accessed by the first host 11.

The host communication device 133 is used to build up a communication channel between the first host 11 and the second host 12. The host communication device 133 is directly connected to the switch 131, e.g., a connection end N4 thereof.

In one aspect, the host communication device 133 includes a first composite device (e.g., shown as USB composite1) 1331 and a second composite device (e.g., shown as USB composite2) 1332. The first composite device 1331 is connected to the hub 132 as a downstream device of the hub 132. The second composite device 1332 is connected to the switch 131, e.g., the connection end N4 thereof. The first composite device 1331 and the second composite device 1332 communicate to each other via a buffer without using a network cable to increase transmission speed.

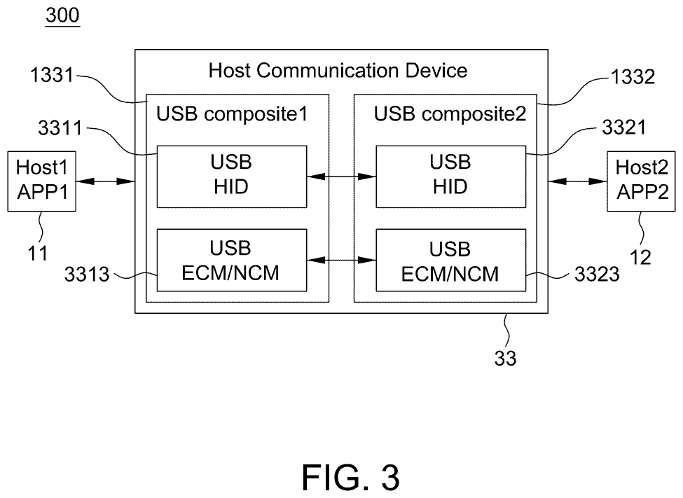

Please refer to FIG. 3, it is a schematic block diagram of a host communication device 13 of a host bridge device 300 (i.e. 133 in FIG. 1) according to one embodiment of the present disclosure. The first composite device 1331 includes at least a human input device (e.g., shown as USB HID) 3311 and a network control module (e.g., shown as USB NCM) 3313. The second composite device 1332 includes at least a human input device 3321 and a network control module 3323.

The network control module 3313 and 3323 may further be replaced by an Ethernet control module (e.g., shown as USB ECM). The USB ECM/NCM 3313 and 3323 are used to transmit proprietary data between the first port (i.e. the first host 11) and the second port (i.e., the second host 12). In one aspect, the proprietary data preferably have large amount of data, e.g., including file data, video data and screen mirroring data, but not limited thereto.

The human input device 3311 and 3321 are used to transmit HID data between the first port and the second port, e.g., including self-defined data, keyboard event raw data or mouse event raw data, but not limited thereto. Other HID data is also transmitted via the human input device 3311 and 3321, e.g., touchpad data.

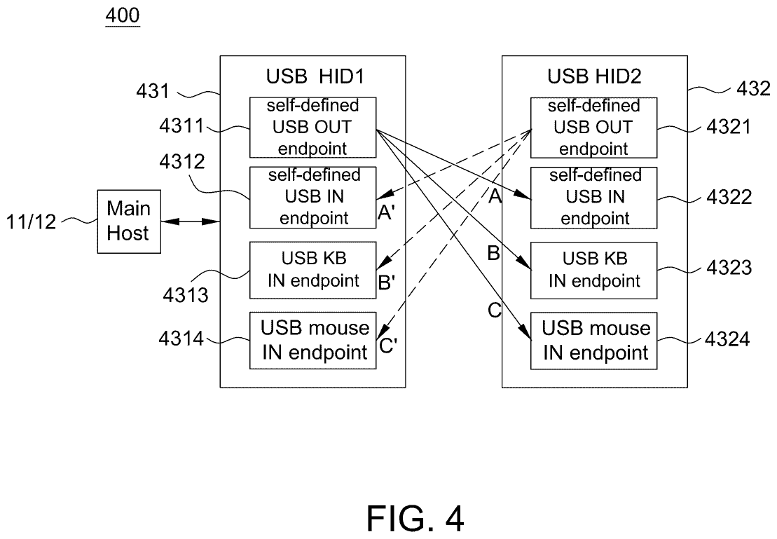

Please refer to FIG. 4, it is an operating method of human input device 431 and 432 of a host communication device 300 of a host bridge device 13 according to one embodiment of the present disclosure. The first HID 431 (e.g., shown as USB HID1 FIGS. 4 and 3311 in FIG. 3) identifies a type of data D1 (e.g., referring to FIG. 1) to accordingly assert a self-defined USB out endpoint 4311, a self-defined USB in endpoint 4312, a USB keyboard in endpoint 4313 and a USB mouse in endpoint 4314. The second HID 432 (e.g., shown as USB HID2 FIGS. 4 and 3321 in FIG. 3) identifies a type of data D2 (e.g., referring to FIG. 1) to accordingly assert a self-defined USB out endpoint 4321, a self-defined USB in endpoint 4322, a USB keyboard in endpoint 4323 and a USB mouse in endpoint 4324.

The self-defined USB out endpoints 4311 and 4321 are used to output self/vendor-defined data, e.g., communication data, which has a self/vendor defined data format, between the first host 11 and second host 12. The self-defined USB in endpoints 4312 and 4322 are used to receive the self/vendor defined data. The USB keyboard in endpoints 4313 and 4323 are used to receive keyboard event raw data. The USB mouse in endpoints 4314 and 4324 are used to receive mouse event raw data.

For example, in the aspect that the first host 11 transmits data to the second host 12 via the host bridge device 13 (i.e. the first host 11 used as a main host), the first application software APP1 is used to output (e.g., via the switch 131 and the hub 132) one of first self-defined data, first keyboard event raw data and first mouse event raw data to the first composite device 1331. The HID1 431 of the first composite device 1331 is used to analyze/identify a received data type (e.g., type of D1) to accordingly output, via the self-defined USB out endpoint 4311, type-identified data to the self-defined USB in endpoint4322 (e.g., shown as data A), to the USB keyboard in endpoint 4323 (e.g., shown as data B) or to the USB mouse in endpoint 4324 (e.g., shown as data C) of the HID2 432 of the second composite device 1332. The second composite device 1332 then transmits the data to the second host 12 via the switch 131

In this way, the first application software APP1 intercepts event data of input devices (e.g., keyboard and mouse, but not limited to) of the first host 11 and transmits the intercepted data to the second host 12 via the host bridge device 13 to correspondingly control operations of the second host 12. Meanwhile, the first application software APP1 may inform the operation system (OS) of the first host 11 to ignore the event data of the input devices thereof.

Similarly, in the aspect that the second host 12 transmits data to the first host 11 via the host bridge device 13 (i.e. the second host 12 used as a main host), the second application software APP2 is used to output (e.g., via the switch 131) one of second self-defined data, second keyboard event raw data and second mouse event raw data to the second composite device 1332. The HID2 432 of the second composite device 1332 is used to analyze/identify a received data type (e.g., type of D2) to accordingly output, via the self-defined USB out endpoint 4321, type-identified data to the self-defined USB in endpoint 4312 (e.g., shown as data A′), to the USB keyboard in endpoint 4313 (e.g., shown as data B′) or to the USB mouse in endpoint 4314 (e.g., shown as data C′) of the HID1 431 of the first composite device 1331. The first composite device 1331 then transmits the data to the first host 11 via the switch 131

In this way, the second application software APP2 intercepts event data of input devices (e.g., keyboard and mouse, but not limited to) of the second host 12 and transmits the intercepted data to the first host 11 via the host bridge device 13 to correspondingly control operations of the first host 11. Meanwhile, the second application software APP2 may inform the operation system (OS) of the second host 12 to ignore the event data of the input devices thereof.

In the present disclosure, the data B, data C, data B′ and data C′ have fixed/general data format.

The method of determining the first host 11 or the second host 12 as the main host may be directly defined by the product or determined by the APP1 or APP2.

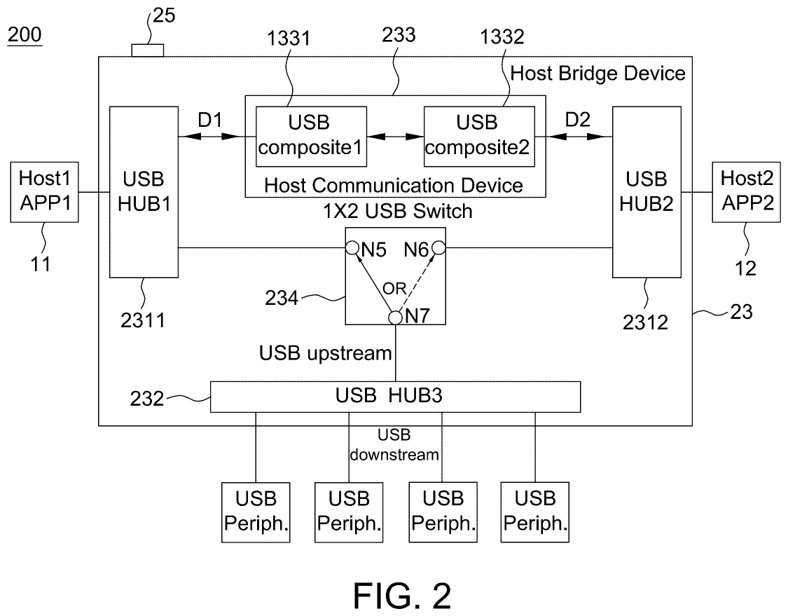

Please refer to FIG. 2, it is a schematic block diagram of a host communication system 200 according to a second embodiment of the present disclosure. The host communication system 200 also includes a host bridge device 23, a first host 11 and a second host 12. The first host 11 and the second host 12 are also able to be plugged in the host bridge device 23 to connect thereto and unplugged from the host bridge device 23 to disconnect therefrom. The first host 11 and the second host 12 have been described above, and thus details thereof are not repeated again.

In the second embodiment, the host bridge device 23 includes a first hub (e.g., shown as USB HUB1), a second hub (e.g., shown as USB HUB2), a third hub (e.g., shown as USB HUB3), a host communication device 233 and a switch 234. The third hub 232 is identical to the hub 132 of the first embodiment to allow multiple USB peripheral devices to plug-in or unplug therefrom, and thus details thereof are not repeated again. The host communication device 233 is identical to the host communication device 133 of the first embodiment, e.g., referring to FIGS. 3 and 4, and thus details thereof are not repeated again.

In the second embodiment, the switching of the switch 234 and data transmission of the host communication device 233 may be performed in parallel and independently without interfering with each other.

In one aspect, the switch is a 1×2 USB switch (abbreviated as switch herein for illustration purposes), and includes connection ends N5 and N6 respectively connected to the first hub 2311 and the second hub 2312. The switch 234 further has a connection end N7 connected to the third hub 232, and is used to switch the USB upstream port of the third hub 232 to be connected to the first hub 2311 or the second hub 2312.

In one aspect, the host bridge device 23 includes a physical button or knob 25, and when the physical button or knob 25 is operated by a user, the switch 234 switches the third hub 232 to be connected to HUB1 2311 or HUB2 2312.

In another aspect, switching of the switch 234 is controlled by the first application software APP1 or the second application software APP2 similar to that described in the first embodiment.

The first hub 2311 includes at least one port for being unplugged or plugged by the first host 11. The second hub 2312 includes at least one port for being unplugged or plugged by the second host 12. The main difference between the second embodiment and the first embodiment is that the host communication device 233 is directly and constantly connected between the first hub 2311 and the second hub 2312 so as to transmit proprietary data and HID data therebetween. The proprietary data and HID data have been illustrated above and thus details thereof are not repeated again.

Similarly, in one aspect, the host communication device 233 includes a first composite device 1331 and a second composite device 1332. As mentioned above, the first composite device 1331 and the second composite device 1332 communicate to each other via a buffer without using a network cable. However, the present disclosure is not limited thereto, the first composite device 1331 and the second composite device 1332 may be connected by a network cable in other aspects.

In the second embodiment, the first composite device 1331 is connected to the first hub 2311. The second composite device 1332 is connected to the second hub 2312.

Similarly, the first composite device 1331 and the second composite device 1332 respectively include a network control module 3313 and 3323 to transmit proprietary data between the first hub 2311 and the second hub 2312, and respectively include an HID device 3311 and 3321 to transmit self/vendor-defined data, keyboard event raw data or mouse event raw data between the first hub 2311 and the second hub 2312, e.g., referring to FIG. 3.

Similarly, the first composite device 1331 and the second composite device 1332 may assert a self-defined USB out endpoint 4311 and 4321 to output the self/vendor-defined data, assert a self-defined USB in endpoint 4312 and 4322 to receive the self/vendor-defined data, to assert a USB keyboard in endpoint 4313 and 4323 to receive the keyboard event raw data, and assert a USB mouse in endpoint 4314 and 4324 to receive mouse event raw data.

For example, in the aspect that the first host 11 is used as a main host, the first application software APP1 is used to output one of first self-defined data, first keyboard event raw data and first mouse event raw data to the first composite device 1331. Please refer to FIG. 4 again, the HID1 431 of the first composite device 1311 is used to analyze/identify a received data type to accordingly output, via the self-defined USB out endpoint 4311, type-identified data to the self-defined USB in endpoint 4322, to the USB keyboard in endpoint 4323 or to the USB mouse in endpoint 4324 of the HID 432 of the second composite device 1332. The second composite device 1332 then transmits the data to the second host 12 via the second hub 2312

In this way, the first application software APP1 intercepts event data of input devices (e.g., keyboard and mouse, but not limited to) of the first host 11 and transmits the intercepted data to the second host 12 via the host bridge device 23 to correspondingly control operations of the second host 12, i.e. the input devices of the first host 11 being able to control the second host 12. Meanwhile, the first application software APP1 may inform the operation system of the first host 11 to ignore the event data of the input devices thereof.

The operations of the second host 21 used as the main host are similar to the first embodiment, and thus details thereof are not repeated again.

The above first embodiment and the second embodiment provide an aspect of a host communication system in which two hosts are wiredly connected to a host bridge device. The present disclosure further provides a host communication system in which one host is wirelessly coupled to a host bridge device. For example, said one host is a portable device having a screen, such as a smart phone.

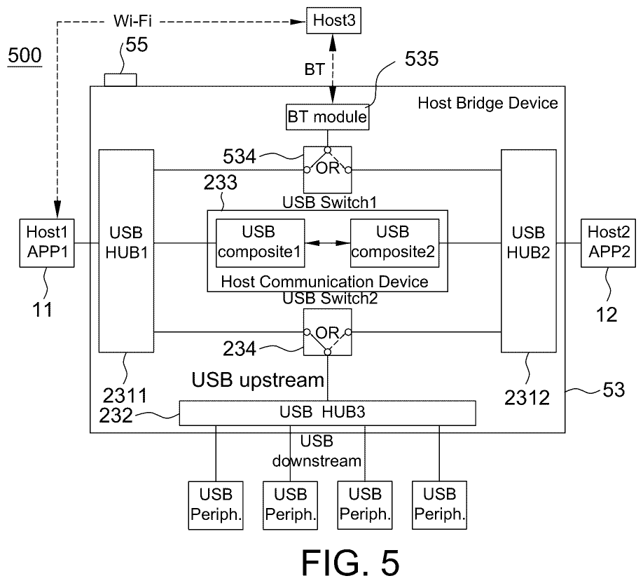

Please refer to FIG. 5, it is a schematic block diagram of a host communication system 500 according to a third embodiment of the present disclosure. The host communication system 200 also includes a host bridge device 53, a first host 11 and a second host 12. The first host 11 and the second host 12 are also able to be plugged in the host bridge device 53 to connect thereto and unplugged from the host bridge device 53 to disconnect therefrom. The first host 11 and the second host 12 have been described above, and thus details thereof are not repeated again.

In the third embodiment, the host bridge device 53 also includes a first hub 2311, a second hub 2312, a third hub 232, a host communication device 233 and a switch 234, which are respectively identical to components in the second embodiment having the same reference numerals and thus details thereof are not repeated again. Similarly, the switch 234 is also operated by a physical button or knob 55.

The main difference between the third embodiment and the second embodiment is that the host bridge device 53 of the third embodiment further includes a Bluetooth module 535 to be connected to the first hub 2311 or the second hub 2312 through the switch 534, which is a USB switch as an example. For example, the Bluetooth module 535 includes a Bluetooth low energy (BLE) chip using a BLE interface to build up a Bluetooth connection with, for example, a smartphone.

In the third embodiment, when both the first host 11 and the second host 12 are wiredly connected to the host bridge device 53, the operations of the host bridge device 53 are identical to those described in the second embodiment, i.e. the host bridge device 53 constructing a communication channel between the first host 11 and the second host 12.

However, when only one of the first host 11 and the second host 12 (e.g., the first host 11) is wiredly connected to the host bridge device 53, the Bluetooth module 535 is Bluetooth coupled to the other host (e.g., the second host 12).

That is, the Bluetooth module 535 is wiredly connected to (e.g., through the switch 534) one of the first hub 2311 (i.e. the first host 11 if plugged-in) and the second hub 2312 (i.e. the second host 12 if plugged-in), and Bluetooth connected to the other one of the first host 11 and the second host 12.

To increase the connection security, the host that is able to form the Bluetooth connection with the Bluetooth module 535 is preferably paired with the first host 11 or the second host 12 without passing the host bridge device 53. The methods of Bluetooth pairing and Bluetooth connecting are known to the art and thus details thereof are not described herein.

In this way, the first application software APP1 intercepts event data of input devices (e.g., keyboard and mouse, but not limited to) of the first host 11, and wiredly or wirelessly transmits the intercepted data to the second host 12 via the host bridge device 53 to correspondingly control operations of the second host 12, i.e. the input devices of the first host 11 being able to control the second host 12. Meanwhile, the first application software APP1 may inform the operation system of the first host 11 to ignore the event data of the input devices thereof.

Or, the second application software APP2 intercepts event data of input devices (e.g., keyboard and mouse, but not limited to) of the second host 12, and wiredly or wirelessly transmits the intercepted data to the first host 11 via the host bridge device 53 to correspondingly control operations of the first host 11, i.e. the input devices of the second host 12 being able to control the first host 11. Meanwhile, the second application software APP2 may inform the operation system of the second host 12 to ignore the event data of the input devices thereof.

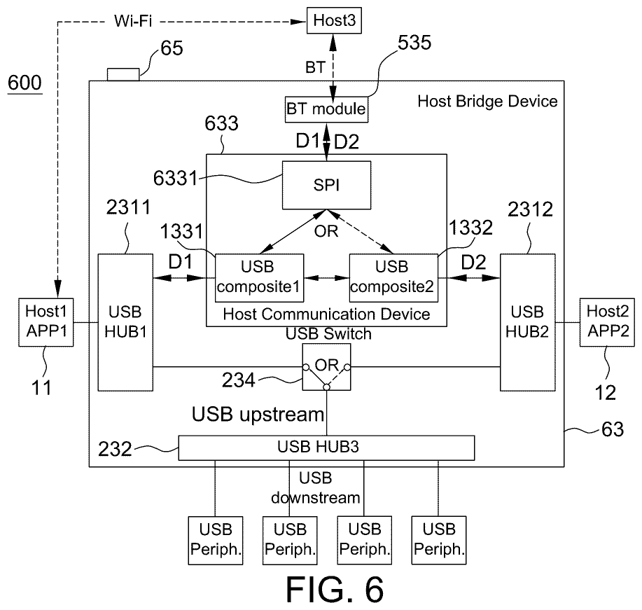

Please refer to FIG. 6, it is a schematic block diagram of a host communication system 600 according to a fourth embodiment of the present disclosure. The host communication system 600 also includes a host bridge device 63, a first host 11 and a second host 12. The first host 11 and the second host 12 are also able to be plugged in the host bridge device 63 to connect thereto and unplugged from the host bridge device 63 to disconnect therefrom. The first host 11 and the second host 12 have been described above, and thus details thereof are not repeated again.

In the fourth embodiment, the host bridge device 63 also includes a first hub 2311, a second hub 2312, a third hub 232 and a switch 234, which are respectively identical to components in the second embodiment having the same reference numerals and thus details thereof are not repeated again. Similarly, the switch 234 is also operated by a physical button or knob 65.

The main difference between the fourth embodiment and the third embodiment is that the host communication device 633 of the host bridge device 63 of the fourth embodiment includes a first composite device (e.g., 1331 in FIG. 3) and a second composite device (e.g., 1332 in FIG. 3) that are coupled to the Bluetooth module 535 via a series parallel interface (SPI) 6331.

The first composite device 1331 is connected to the first hub 2311. The second composite device 1332 is connected to the second hub 2312. The SPI 6331 is used to couple the Bluetooth module 535 to the first composite device 1331 or the second composite device 1332. For example, the fourth embodiment uses software to switch a composite device coupled to the Bluetooth module 535.

In another aspect, the SPI 6331 is fixed to be connected to one of the two composite devices, e.g., the first composite device 1331. In this aspect, the first hub 2311 is constantly connected to the first host 11 wiredly, and the second host 12 is wiredly connected to the second composite device 1332 (e.g., via the second hub 2312) or wirelessly coupled to the SPI 6311 (e.g., via the Bluetooth module 535).

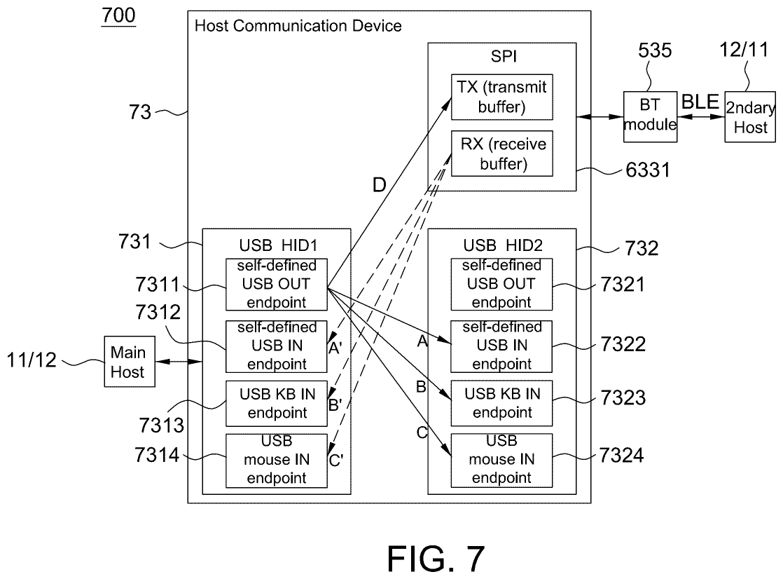

Similarly, the first composite device 1331 and the second composite device 1332 respectively include a network control module (e.g., 3313 and 3323 shown in FIG. 3) to transmit proprietary data between the first hub 2311 and the second hub 2312. The first composite device 1331 and the second composite device 1332 respectively further include an HID (e.g., 731 and 732 shown in FIG. 7) to transmit self/vendor-defined data, keyboard event raw data and mouse event raw data between the first hub 2311 and the second hub 2312 or between the first hub 2311 and the Bluetooth module 535 (via the SPI 6331).

Please refer to FIG. 7, the first HID (e.g., shown as USB HID1) 731 is also able to assert a self-defined USB out endpoint 7311, a self-defined USB in endpoint 7312, a USB keyboard in endpoint 7313 and a USB mouse in endpoint 7314; and the second HID (e.g., shown as USB HID2) 732 is also able to assert a self-defined USB out endpoint 7321, a self-defined USB in endpoint 7322, a USB keyboard in endpoint 7323 and a USB mouse in endpoint 7324, which have been described above and thus details thereof are not repeated herein.

The main difference between the embodiment of FIG. 4 and the embodiment of FIG. 7 is that in FIG. 7 when the first application software APP1 knows that (e.g., informed by the second composite device 1332 or the second hub 2312) that the connection port of the second hub 2312 is not plugged in by the second host 12, the communication data D1 is sent to the SPI 6331. The Bluetooth module 535 analyzes/identifies a type of communication data D1 (i.e. identifying data A, B or C), and then transmits the communication data D1 to the second host 12. That is, the first composite device 1331 needs not to analyze/identify the type of communication data D1 when the communication data D1 is sent to the SPI 6331. However, when the first composite device 1331 knows that the connection port of the second hub 2312 is plugged in by the second host 12, the first composite device 1331 analyzes/identifies a type of communication data D1 and then transmits the communication data D1 to the self-defined USB in endpoint 7322, the USB keyboard in endpoint 7323 or the USB mouse in endpoint 7324, similar to the second embodiment.

When the Bluetooth module 535 receives data from the second host 12, the SPI 6331 (e.g., a receive buffer thereof) analyzes/identifies a type of the received data, and then transmits the type-analyzed data to the self-defined USB in endpoint 7312 (e.g., shown as data A′), the USB keyboard in endpoint 7313 (e.g., shown as data B′) or the USB mouse in endpoint 7314 (e.g., shown as data C′).

In another aspect, the first HID 731 includes two self-defined USB out endpoints respectively used to transmit data to the SPI 6331 and the second HID 732 depending on whether the second host 12 is connected to the second hub 2312 or coupled to the Bluetooth module 535.

Similarly, the main host in FIG. 7 may be one of the first host 11 and the second host 12.

The embodiment of FIG. 7 is described in the way that the first host 11 is used as a main host and the second host 12 is used as a secondary host. In the aspect that the second host 12 is used as the main host and the first host 11 is used as the secondary host, the communication channel is formed between the second HID 732 and the SPI 6331.

In the third embodiment and the fourth embodiment, when the first host 11 is wiredly connected to the first hub 2311 and the second host 12 is wiredly connected to the second hub 2312, the Bluetooth module 535 may further be coupled to a Host3, which is preferably paired with the BT module 535 previously, to construct a BT connection therebetween. The first host 11 or the second host 12 is able to (e.g., controlled by APP1 and APP2) construct a Wi-Fi connection (based on the state of switch 534, and the first hub 2311 being taking as an example herein) with the Host3 by communicating via the BT connection to transmit proprietary data with the Host3 via the Wi-Fi connection after the Wi-Fi connection is built-up.

It should be mentioned that although the host communication devices of every embodiment of the present disclosure are described by including two composite devices as an example, the present disclosure is not limited thereto. In other aspects, said two composite devices may be combined as a single composite device. In other aspects, the host communication device is used as a communication channel between more than two hosts.

It should be mentioned that values mentioned in the present disclosure, e.g., a number of USB peripheral devices, a number of input/out connection ends of the USB switches, are only intended to illustrate but not to limit the present disclosure.

As mentioned above, the conventional USB switches are not able to provide communication between different hosts such that they cannot used to transmit file data, video data and screen data directly. Accordingly, the present disclosure further provides a host bridge device (e.g., referring to FIGS. 1-2 and 5-6) that is embedded with a host communication device for realizing the transmission of proprietary data and human input device (HID) data between different hosts. Furthermore, the host bridge device is able to switch the access right of multiple USB peripheral devices between the different hosts using a USB switch.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A host bridge device, comprising:
a first port and a second port;
a switch, comprising a first connection end and a second connection end respectively connected to the first port and the second port;
a hub, directly connected to a third connection end of the switch; and
a host communication device, directly connected to a fourth connection end of the switch.

2. The host bridge device as claimed in claim 1, wherein the switch is a 2×2 universal serial bus (USB) switch and configured to
couple the first port to one of the hub and the host communication device, and
couple the second port to the other one of the hub and the host communication device.

3. The host bridge device as claimed in claim 1, wherein the host communication device comprises:
a first composite device, connected to the hub; and
a second composite device, connected to the fourth connection end of the switch.

4. The host bridge device as claimed in claim 3, wherein the first composite device and the second composite device respectively comprise:
a network control module, configured to transmit proprietary data between the first port and the second port; and
a human input device, configured to transmit self-defined data, keyboard event raw data or mouse event raw data between the first port and the second port.

5. The host bridge device as claimed in claim 4, wherein the proprietary data comprises file data, video data and screen mirroring data.

6. The host bridge device as claimed in claim 4, wherein the human input device of the first composite device and the second composite device comprises:
a self-defined USB out endpoint, configured to output the self-defined data;
a self-defined USB in endpoint, configured to receive the self-defined data;
a USB keyboard in endpoint, configured to receive the keyboard event raw data; and
a USB mouse in endpoint, configured to receive the mouse event raw data.

7. The host bridge device as claimed in claim 6, wherein
the first port is configured to plug-in or unplug a first host, which is embedded with a first application software configured to output one of first self-defined data, first keyboard event raw data and first mouse event raw data to the first composite device, and
the human input device of the first composite device is configured to identify a data type of received data and output, via the self-defined USB out endpoint thereof, identified data to the self-defined USB in endpoint, the USB keyboard in endpoint or the USB mouse in endpoint of the human input device of the second composite device.

8. A host bridge device, comprising:
a first hub, configured to be coupled to a first host;
a second hub, configured to be coupled to a second host;
a third hub, configured to be coupled to multiple USB peripheral devices;
a host communication device, directly connected between the first hub and the second hub; and
a switch, configured to couple the third hub to the first hub or the second hub.

9. The host bridge device as claimed in claim 8, wherein the host communication device comprises:
a first composite device, connected to the first hub; and
a second composite device, connected to the second hub.

10. The host bridge device as claimed in claim 9, wherein the first composite device and the second composite device respectively comprise:
a network control module, configured to transmit proprietary data between the first hub and the second hub; and
a human input device, configured to transmit self-defined data, keyboard event raw data or mouse event raw data between the first hub and the second hub.

11. The host bridge device as claimed in claim 10, wherein the proprietary data comprises file data, video data and screen mirroring data.

12. The host bridge device as claimed in claim 10, wherein the human input device of the first composite device and the second composite device comprises:
a self-defined USB out endpoint, configured to output the self-defined data;
a self-defined USB in endpoint, configured to receive the self-defined data;
a USB keyboard in endpoint, configured to receive the keyboard event raw data; and
a USB mouse in endpoint, configured to receive the mouse event raw data.

13. The host bridge device as claimed in claim 12, wherein
the first host is embedded with first application software configured to output one of first self-defined data, first keyboard event raw data and first mouse event raw data to the first composite device, and
the human input device of the first composite device is configured to identify a data type of received data and output, via the self-defined USB out endpoint thereof, identified data to the self-defined USB in endpoint, the USB keyboard in endpoint or the USB mouse in endpoint of the human input device of the second composite device.

14. The host bridge device as claimed in claim 10, wherein the switching of the switch and data transmission of the host communication device are performed in parallel.

15. A host bridge device, comprising:
a first hub, configured to be coupled to a first host;
a second hub, configured to be coupled to a second host;
a host communication device, directly connected between the first hub and the second hub; and
a Bluetooth module, configured to be wiredly connected to one of the first host and the second host, and wirelessly coupled to the other one of the first host and the second host.

16. The host bridge device as claimed in claim 15, further comprising:
a third hub, configured to be coupled to multiple USB peripheral devices; and
a switch, configured to couple the third hub to the first hub or the second hub.

17. The host bridge device as claimed in claim 15, wherein the Bluetooth module is wiredly connected to the first hub or the second hub via a switch.

18. The host bridge device as claimed in claim 15, wherein the Bluetooth module is wiredly connected to the first hub or the second hub via the host communication device, the host communication device comprises:
a first composite device, connected to the first hub;
a second composite device, connected to the second hub; and
a serial peripheral interface (SPI), configured to couple the Bluetooth module to the first composite device or the second composite device.

19. The host bridge device as claimed in claim 18, wherein the first composite device and the second composite device respectively comprise:
a network control module, configured to transmit proprietary data between the first hub and the second hub or between the first hub and the SPI; and
a human input device, configured to transmit self-defined data, keyboard event raw data or mouse event raw data between the first hub and the second hub or between the first hub and the SPI.

20. The host bridge device as claimed in claim 19, wherein the human input device of the first composite device and the second composite device comprises:
a self-defined USB out endpoint, configured to output the self-defined data, the keyboard event raw data or the mouse event raw data to the second composite device or to the SPI.
